(19) United States
(12) Patent Application Publication
(10) Pub. No.: US 2003/0043459 A1
(43) Pub. Date: Mar. 6, 2003

(54) Differential interference microscope

(76) Inventor: Kumiko Matsui, Yokohama-shi (JP)

Correspondence Address: MILES & STOCKBRIDGE PC, 1751 PINNACLE DRIVE, SUITE 500, MCLEAN, VA, 22102-3833, US

(21) Appl. No.: 10/179,853

(22) Filed: Jun. 26, 2002

(30) Foreign Application Priority Data
Jun. 27, 2001 (JP) 2001-194889

(51) Int. Cl. G02B 21/00; G02B 21/06; G02B 5/30; G02B 27/28

(52) U.S. Cl. 359/386; 359/368; 359/371; 359/385; 359/483

(57) ABSTRACT

In a differential interference microscope, polarized light having a predetermined direction of oscillation is incident on a birefringent optical member so as to be separated into two linearly polarized light components having directions of oscillation orthogonal to each other, and the two linearly polarized light components thus separated are directed via an objective lens to a sample to be observed, and the two linearly polarized light components reflected from the sample are guided via the objective to the birefringent optical member so as to be synthesized into single light, and two linearly polarized light components of the synthesized light flux are caused to interfere so that an image of the sample is formed by the objective lens from the light flux that have interfered. The birefringent optical member has a wedge surface and a reference plane, and the birefringent optical member is inclined, in a plane including an optical axis and a normal line of the wedge surface, with respect to a plane perpendicular to an optical axis in a wedge angle direction by an angle that falls within the range of 16 to 40 degrees.

The disclosure of the following priority application is herein incorporated by reference: Japanese Patent Application No. 2001-194889 filed on Jun. 27, 2001.

### BACKGROUND OF THE INVENTION

1. Field of the Invention

The present invention relates to a differential interference microscope and, more particularly, to a differential interference microscope that uses a birefringent optical member.

2. Related Background Art

As a kind of an optical system of conventional differential interference microscopes, there is a reflection type (or reflected illumination type) differential interference microscope.

In the reflection type differential interference microscope, illumination light emitted from a light source is condensed by a collector lens and reflected by a beam splitter, from which the illumination light makes for an objective lens, which also functions as a condenser lens, and passes through the objective lens to illuminate a specimen (or a sample). Reflected illumination light from the specimen is then condensed by the objective lens, so that the light component passing through the beam splitter is focused to form a magnified image. A light polarizer is disposed in the optical path between the collector lens and the beam splitter. In the optical path between the beam splitter and the objective lens and in the vicinity of the rear focal plane of the objective lens, there is provided a birefringent optical member, which is inclined slightly (i.e. a few degrees or less) in order to eliminate influence of reflected light generated at a surface of the birefringent optical member. Furthermore, an analyzer is disposed in the optical path between the beam splitter and the magnified image. In the above-described conventional arrangement, a Wollaston prism or a Nomarski prism is generally used as a birefringent optical member. The Wollaston prism and Nomarski prism are formed by cementing two wedge prisms made of a birefringent optical material (e.g. a crystal like quartz or calcite) in such a way that their optical axes are orthogonal to each other.

The differential interference microscope as described above suffers from a problem that unevenness in brightness or in color appears in the field of observation view as shown in FIG. 6, due to aberrations peculiar to crystals used for the Wollaston prism or Nomarski prism so as to impair homogeneity of the field of view. Such unevenness generally appears at peripheral areas in the field of view in a direction of shear and a direction perpendicular to the direction of shear. Prior art solutions disclosed in Japanese Patent Publication No. 61-3409 and Japanese Patent Application Laid-open No. 2-151825 were intended to solve that problem.

However in the apparatus disclosed in Japanese Patent Publication No. 61-3409, it was necessary to additionally provide a compensator made of a crystal in order to cancel a phase difference generated in connection with the aberrations peculiar to the crystals. In the apparatus disclosed in Japanese Patent Application Laid-open No. 2-151825, it was necessary to use a combination of a positive crystal and negative crystal, which are of opposite optical properties, in order to cancel the phase difference same as described above. Generally, crystalline materials are expensive, and negative crystals are especially expensive as compared to the positive crystals. In addition, many of the negative crystals are difficult to process.

### SUMMARY OF THE INVENTION

The present invention has been made in view of the above-mentioned problem. An object of the present invention is to provide a differential interference microscope that can form a good-quality differential interference image having a high contrast.

To achieve the object, according to the present invention there is provided a differential interference microscope in which polarized light having a predetermined direction of oscillation is incident on a birefringent optical member so as to be separated into two linearly polarized light components having directions of oscillation orthogonal to each other, and the two linearly polarized light components thus separated are directed via an objective lens to a sample to be observed, and the two linearly polarized light components reflected from the sample are guided via the objective lens to the birefringent optical member so as to be synthesized into single light, and two linearly polarized light components of the synthesized light flux are caused to interfere so that an image of the sample by means of the objective lens is formed from the light flux that have interfered, wherein the birefringent optical member has a wedge surface and a reference plane, and the birefringent optical member is inclined, in a plane including an optical axis and a normal line of the wedge surface, with respect to a plane perpendicular to an optical axis in a wedge angle direction by an angle that falls within the range of 16 to 40 degrees.

In the differential interference microscope according to the present invention, it is preferable that the birefringent optical member comprise a Nomarski prism.

According to the invention, there is further provided a differential interference microscope, in which polarized light having a predetermined direction of oscillation is incident on a first birefringent optical member so as to be separated into two linearly polarized light components having directions of oscillation orthogonal to each other, and the two linearly polarized light components thus separated are directed via an illuminating optical system to a sample to be observed, and the two linearly polarized light components reflected from or transmitted through the sample are guided via an objective lens to a second birefringent optical member so as to be synthesized into single light, and two linearly polarized light components of the synthesized light flux are caused to interfere so that an image of the sample is formed by the objective lens from the light flux that have interfered, wherein each of the first and second birefringent optical members has a wedge surface and a reference plane, and at least one of the first and second birefringent optical members is inclined, in a plane including an optical axis and a normal line of the wedge surface, with respect to a plane perpendicular to an optical axis in a wedge angle direction by an angle that falls within the range of 16 to 40 degrees.

In this differential interference microscope according to the present invention, it is preferable that at least one of the first and second birefringent optical members comprise a Nomarski prism.

In the differential interference microscopes according to the present invention, it is more preferable that the angle of inclination of the birefringent optical member be in the range of 25 to 35 degrees.

### BRIEF DESCRIPTION OF THE DRAWINGS

FIG. 1 is a drawing schematically showing a structure of an optical system of a reflected illumination type differential interference microscope as the first embodiment of the present invention.

FIGS. 2A and 2B are magnified views of a birefringent optical member used in the embodiment of the present invention.

FIG. 3 is a graph that demonstrates an effect of the present invention based on a calculation.

FIG. 4 is a graph schematically explaining a principle of the present invention.

FIG. 5 is a drawing schematically showing a structure of an optical system of a transmitted illumination type differential interference microscope as the second embodiment of the present invention.

FIG. 6 is a drawing schematically illustrating unevenness in the field of view of a microscope.

FIG. 7 is a drawing illustrating a slider for holding a birefringent optical member used in the embodiments.

### DESCRIPTION OF THE PREFERRED EMBODIMENTS

In the following, embodiments of the present invention will be described with reference to the annexed drawings.

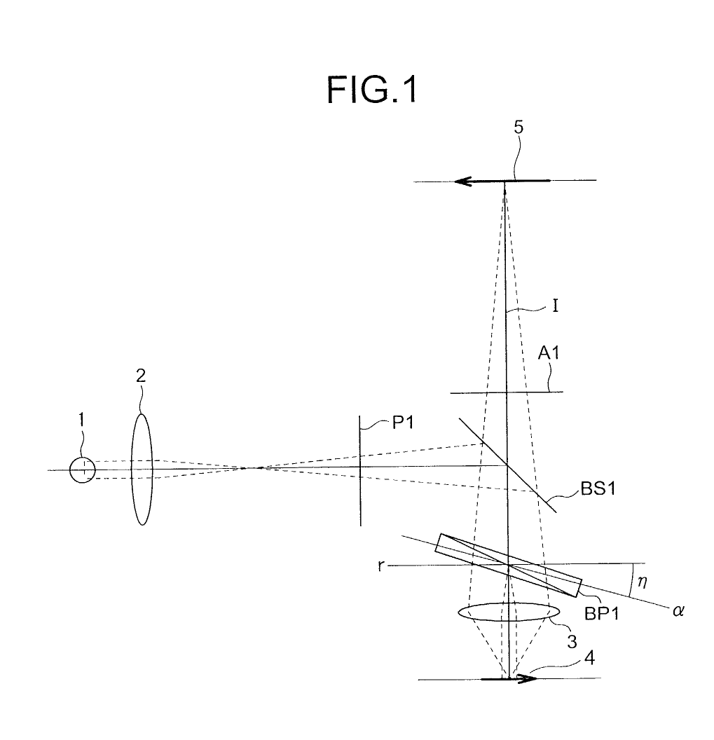

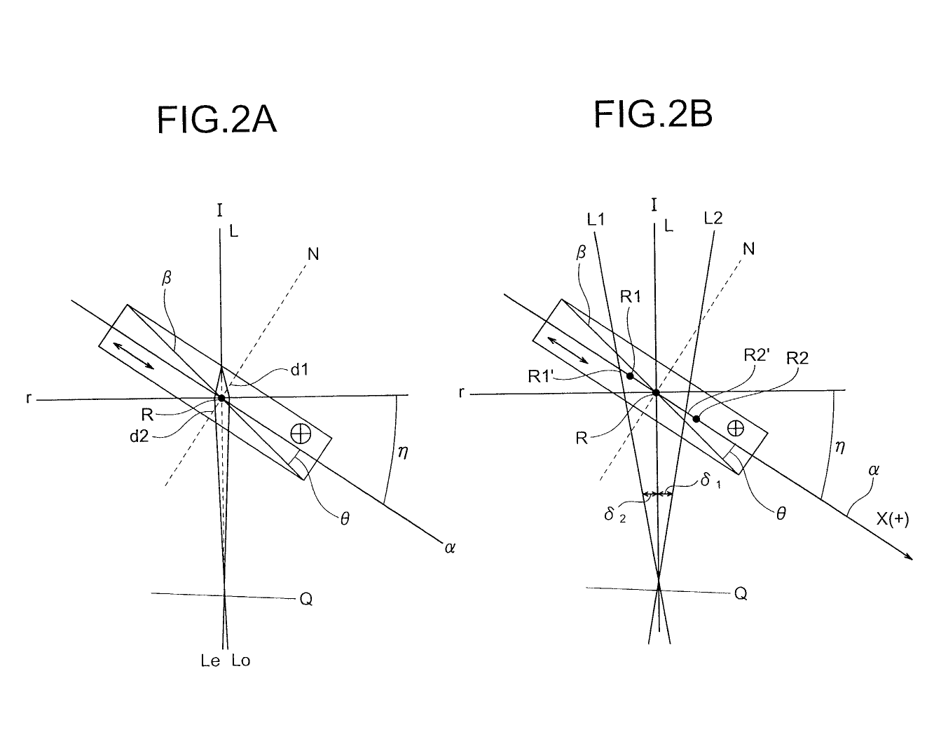

FIG. 1 is a schematic view illustrating the structure of an optical system of a reflection type differential interference microscope as the first embodiment of the present invention. FIGS. 2A and 2B are magnified views of a birefringent optical member BP1.

In the reflection type differential interference microscope shown in FIG. 1, illumination light from a light source 1 is condensed by a collector lens 2 and reflected by a beam splitter BS1, from which the illumination light makes for an objective lens 3, which also functions as a condenser lens, and passes through the objective lens 3 to illuminate a specimen (or sample) 4. Reflected illumination light from the specimen 4 is condensed by the objective lens 3, so that the light component passing through the beam splitter BS1 is focused to form a magnified image 5. A light polarizer P1 is disposed in the optical path between the collector lens 2 and the beam splitter BS1. In the optical path between the beam splitter BS1 and the objective lens 3 and in the vicinity of the rear focal plane of the objective lens 3, there is provided a birefringent optical member BP1. The birefringent optical member BP1 comprises a Nomarski prism, which is inclined in the wedge angle direction of the prism (i.e. the direction of θ shown in FIGS. 2A and 2B) with respect to a plane γ that is perpendicular to an optical axis I by an inclination angle η. Furthermore, an analyzer A1 is disposed in the optical path between the beam splitter BS1 and the magnified image 5.

In the above-described arrangement, the illumination light that has been emitted from the light source 1 and condensed by the collector lens 2 is polarized by the polarizer P1 to become linearly polarized light, and then, after reflected by the beam splitter BS1, separated into an ordinary ray and an extraordinary ray by a birefringence effect of the birefringent optical member BP1. These two rays are linearly polarized respectively with directions of oscillation being perpendicular to the optical axis and orthogonal to each other. After passing through the birefringent optical member BP1, these separated rays travel with a slight angle of separation to each other. Then, at the objective lens 3, they are changed by the condensing effect of the objective lens 3 into parallel rays with a slight distance therebetween so as to be delivered to the sample 4. In connection with this, that slight distance between the two parallel rays is called an amount of shear, and the direction of separation of the parallel rays on the plane of the sample is called a direction of shear or shear direction. The two rays having been reflected at positions slightly spaced apart from each other on the plane of the sample 4 are condensed by the condensing effect of the objective lens 3 onto the birefringent optical member BP1, at which they are made into a single ray by the birefringence effect of the birefringent optical member BP1 so as to travel on the identical optical path and to pass through the beam splitter BS1. After that, at the analyzer A1, oscillation components in the same direction are extracted from the linearly polarized lights orthogonal to each other so as to be subjected to interference, so that an interference pattern in accordance with a phase difference imparted between the two rays upon reflected at positions slightly spaced apart from each other on the sample 4 is observed as the magnified image 5.

FIG. 2A shows a magnified view of the birefringent optical member BP1. In FIG. 2A, a reference plane of the birefringent optical member BP1 is denoted by α, wedge surface thereof is denoted by β and a plane perpendicular to the optical axis I is denoted by γ. The birefringent optical member BP1 is disposed in a so inclined manner that the angle η formed by the reference plane α of the birefringent optical member BP1 and the plane γ perpendicular to the optical axis I would be in the range of 16 to 40 degrees. Here, the reference plane α is a plane that is parallel to the upper surface of the birefringent optical member BP1 and including the intersecting point R of the optical axis I and the plane γ perpendicular to the optical axis I. Upon passing through the birefringent optical member BP1, a ray L on the optical axis I is separated into a ray Lo and a ray Le. The two rays Lo and Le intersect with each other on a ray separating plane Q outside the birefringent optical member BP1. Incidentally, the wedge direction is defined as a direction of inclination of the wedge surface β with respect to the reference plane a (i.e. the direction denoted with θ).

In the following, a description will be made of a relationship between the inclination angle η of the birefringent optical member BP1 and unevenness appearing in the shear direction in the case of the first embodiment.

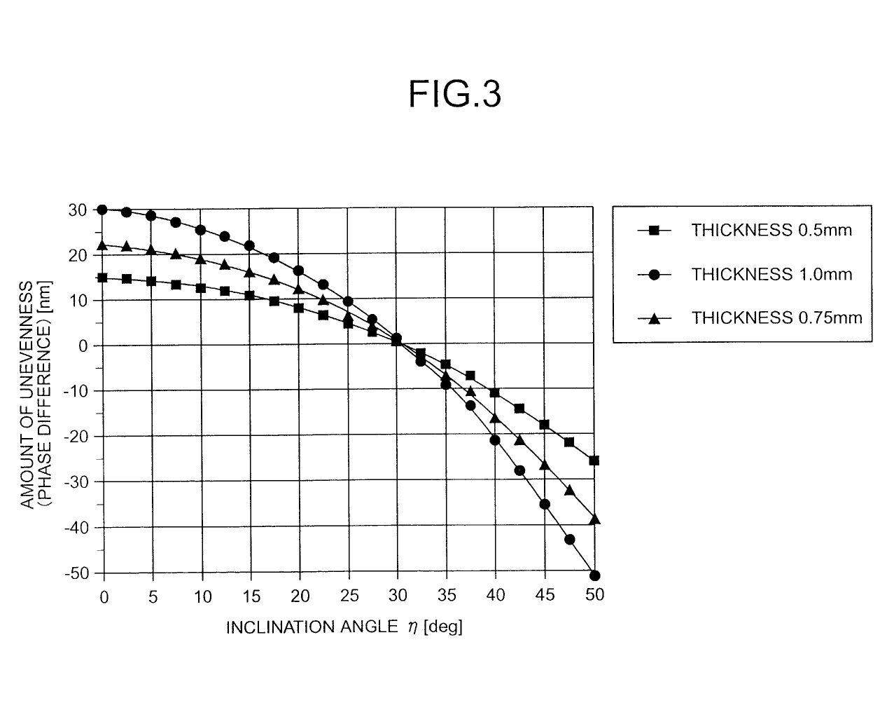

In FIG. 2A, a normal line of the reference plane α at the intersecting point R is denoted by N. the thicknesses along the normal line N, of the two crystal wedge prisms that constitute the birefringent optical member BP1 are denoted by d1 and d2 respectively, and an inclination angle of the wedge surface β with respect to the reference plane α is denoted by θ. Specifically, d1=d2=0.5 mm, θ=15 arcminutes, and the angle with respect to the reference plane α, of the optic axis of the second wedge prism is zero, in other words, the optic axis of the second wedge prism is parallel to the reference plane α, as shown by double-sided arrows in FIGS. 2A and 2B. Under those conditions, the variation of the unevenness appearing in the shear direction as the inclination angle η of the birefringent optical member BP1 is gradually increased from zero was calculated, and the result is shown as a graph in FIG. 3.

In the graph of FIG. 3, the axis of abscissa represents the inclination angle η of the birefringent optical member BP1, and the axis of ordinate represents an amount of unevenness, in terms of a phase difference (or an amount of retardation (nm)), at an outermost position in the shear direction in the field of view of the microscope image relative to the center of the field of view. Here, the birefringent optical member BP1 was assumed to be made of quartz, and the wavelength of the light emitted by the light source was assumed to be 546 nm. In addition, the calculation was effected under the assumption that the angles δ1 and δ2 (FIG. 2B) formed by the principal rays L1 and L2 at outermost positions in the field of view of the microscope image and the optical axis I at the ray separating plane Q are −3.6 degrees and +3.6 degrees respectively. From the graph of FIG. 3, it would be seen that the amount of unevenness gradually decreases as the inclination angle η increases, and the amount of unevenness becomes substantially zero in the vicinity of η=33 [deg]. As the inclination angle η further increases, the amount of unevenness increases in the minus direction. As per the above, it has become apparent based on the numerical calculation that as the inclination angle η of the birefringent optical member BP1 is increased, the amount of unevenness in the shear direction is significantly reduced in a certain range of the inclination angle η.

This phenomenon will be schematically explained as follows. In FIG. 2B, the ray on the optical axis is denoted by L and the principal rays in the outermost positions are denoted by L1 and L2. Here, the X-axis is taken to be along the intersecting line of the reference plane α and the plane of the sheet of the drawing, wherein the origin (X=0) is taken to be at the intersecting point R and the direction to the right represents X>0. Furthermore, it is presumed that the status of the inclination angle η shown in FIGS. 2A and 2B represents η>0. Assume that the X coordinates of the points at which the principal rays L1 and L2 intersect with the reference plane α under the inclination angle η=0 are R1 and R2 respectively, and that the X coordinates of the points at which the principal rays L1 and L2 intersect with the reference plane α under the inclination angle η>0 are R1′ and R2′ respectively, the following relation holds:

|R1′|>|R1|=|R2|>|R2′| (the sign || indicates the absolute value).

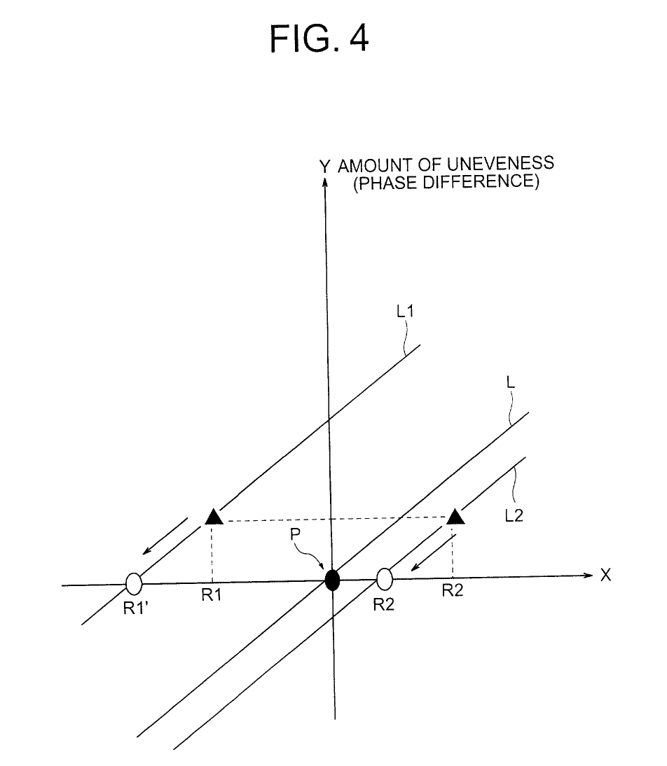

FIG. 4 shows a graph in which the X-axis coordinate is taken as the abscissa and the amounts of unevenness (i.e. phase differences) generated with respect to the rays L, L1 and L2 are presented on the ordinate Y. In this graph, the solid black circle represents the amount of unevenness at the point P, that is the amount of unevenness with respect to the ray L on the optical axis under the condition η=0. The solid black triangles represent the amounts of unevenness with respect to the rays L1 and L2 under the condition η=0. In this state, the amounts of unevenness with respect to rays L1 and L2 are the same. When the birefringent optical member BP1 is inclined so that the inclination angle η becomes more than zero (η>0), the black triangles shift in the direction toward white circles as shown by arrows in FIG. 4. Accordingly, the amounts of unevenness with respect to the rays L1 and L2 become smaller than those under the condition η=0. Therefore, as the inclination angle η is gradually increased, the unevenness in the field of view is reduced, and the amount of unevenness becomes substantially zero at a certain inclination angle η.

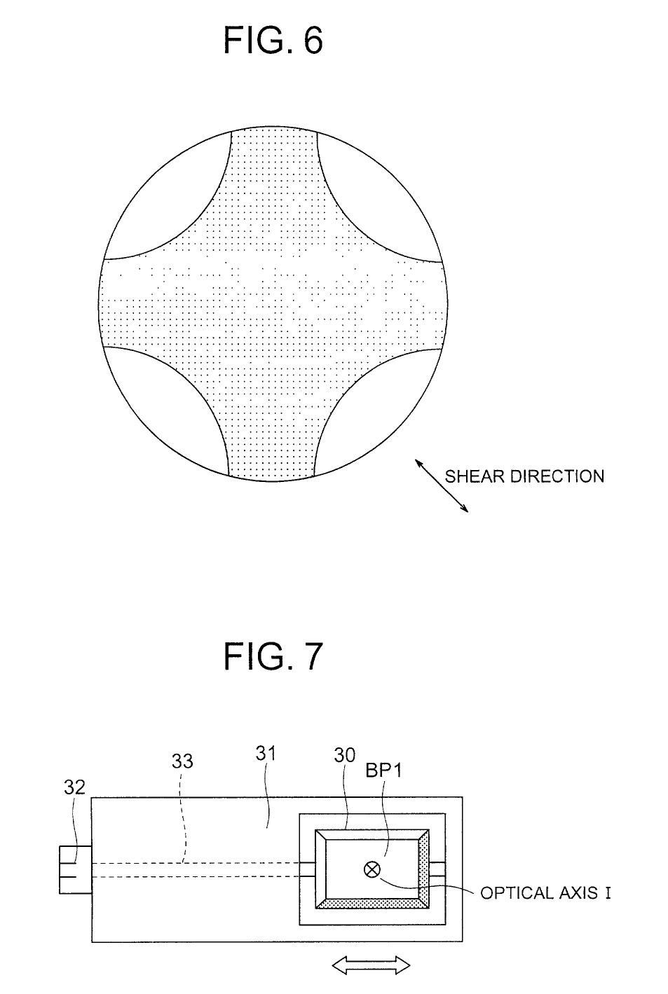

In practice, the value of the inclination angle η at which the amount of unevenness becomes zero varies depending on the composition of the birefringent optical member BP1. However, we have determined, based on calculations with respect to various birefringent optical members, that preferable inclination angles η fall within the range of about 16 to 40 degrees. FIG. 3 shows relationships between the amount of unevenness (in terms of the phase difference (nm)) and the inclination angle η (deg) for plurality of birefringent optical members having differenct thicknesses (d1 and d2), specifically the thicknesses of 0.5 mm, 0.75 mm and 1.0mm. The birefringent optical member is made of a crystalline member such as quartz and the thickness of the birefringent optical member and the amount of unevenness are in a proportional relationship. Therefore, the smaller the thickness is, the greater the unevenness is reduced. However, from the viewpoint of manufacturing, the thicknesses of manufacturable birefringent optical members cannot be excessively small. On the other hand, if the thickness of the birefringent optical member is too large, the unevenness shown in FIG. 6 becomes worse. With the above-mentioned situations, a practical range for the thickness of the birefringent optical member is about 0.5 to 1 millimeters.

It is considered that the amount of unevenness with which a clear image as an image observed with a microscope can be expected would be required to be within the range of about ±10 nm. In FIG. 3, in the case of the thickness of 0.5 mm (that is the lower limit of the practical thickness range), the range of the inclination angle that corresponds to the amount of unevenness within the range of about ±10 nm is about 16 to 40 degrees. In the case of the thickness of 1 mm, the range of the inclination angle that corresponds to the amount of unevenness within the range of about ±10 nm is about 25 to 35 degrees. Therefore, for birefringent optical members with practically usable thicknesses, it is preferable to set the inclination angle within the range of about 16 to 40 degrees, and more preferably within the range of about 25 to 35 degrees.

Generally, as the inclination angle η is increased, the ray separating plane Q shifts away from the reference plane α. Therefore, it is necessary to shift the position of the birefringent optical member in the optical axis direction in accordance with the inclination angle η of the birefringent optical member so that the ray separating plane Q would coincide with the rear focal plane of the objective lens 3.

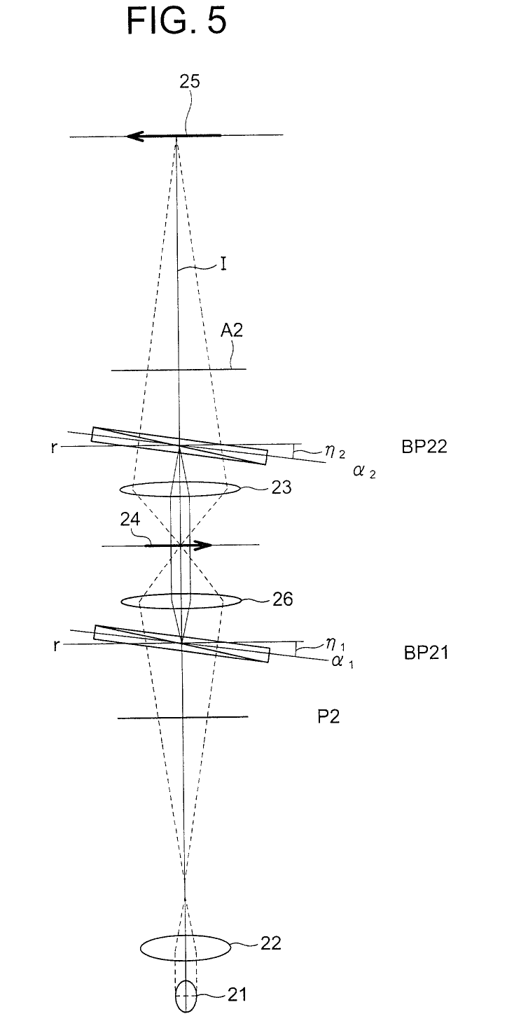

In the following, the second embodiment of the present invention will be described with reference to the drawings. FIG. 5 is a schematic view illustrating the structure of an optical system of the second embodiment of the invention. The second embodiment is a differential interference microscope of a transmitted illumination type.

As shown in FIG. 5, the transmitted illumination type differential interference microscope comprises a light source 21, a polarizer P2, a first birefringent optical member BP21, and a condenser lens 26 for illuminating the sample, all of which are disposed below a sample 24. The transmitted illumination type differential interference microscope also comprises a second birefringent optical member BP22 and an analyzer A2 disposed between an objective lens 23 and a magnified image 25. The first birefringent optical member BP21 is disposed in the vicinity of the front focal plane of the condenser lens 26, while the second birefringent optical member BP22 is disposed in the vicinity of the rear focal plane of the objective lens 23.

In the above arrangement, illumination light emitted from the light source 21 is polarized by the polarizer P2 to become a linearly polarized light and then separated into an ordinary ray and an extraordinary ray by a birefringence effect of the first birefringent optical member BP21. After passing through the first birefringent optical member BP21, these separated rays travel with a slight angle of separation to each other. Then, at the condenser lens 26, they are changed by the condensing effect of the condenser lens 26 into parallel rays with a slight distance therebetween so as to illuminate the sample 24. The two rays having been transmitted through positions slightly spaced apart from each other on the sample 24 are condensed by the condensing effect of the objective lens 23 onto the second birefringent optical member BP22, at which they are made into a single ray by the birefringence effect of the birefringent optical member BP22 so as to travel on the identical optical path. After that, at the analyzer A2, oscillation components in the same direction are extracted from the linearly polarized lights orthogonal to each other so as to be subjected to interference, so that an interference pattern in accordance with a phase difference imparted between the two rays upon transmitted through positions slightly spaced apart from each other on the sample 24 is observed as the magnified image 25.

In the arrangement shown in FIG. 5, the reference planes of the first and second birefringent optical members BP21 and BP22 are denoted by α1 and α2, the wedge surfaces thereof are denoted by β1 and β2, and planes perpendicular to the optical axis I are denoted by γ. At least one of the first and second birefringent optical members BP21 and BP22 is disposed in such an inclined manner that inclination angle η1 or η2 of the reference surface α1 or α2 of the first or second birefringent optical member BP21 or BP22 with respect to the plane γ perpendicular to the optical axis falls within the range of 16 to 40 degrees. Here, the reference planes α1 and α2 are planes that are parallel to the upper surfaces of the respective birefringent optical members BP21 and BP22 and including the respective intersecting points R of the optical axis I and the planes γ perpendicular to the optical axis I.

This differential interference microscope according to the second embodiment is structured as a so-called transmitted illumination type in which illumination light is transmitted through a sample. However, the second embodiment may be modified into a differential interference microscope of a reflected illumination type by obliquely disposing the illuminating optical system and the imaging optical system in a manner in which they are opposed to each other so that light from the illuminating optical system is reflected by the surface of a sample and imaged by the imaging optical system.

The structures, functions and effects of the first and second birefringent optical members used in the second embodiment are the same as those of the birefringent optical member used in the first embodiment, so the detailed description thereof will be omitted.

In the foregoing descriptions, Nomarski prisms produced by cementing two wedge prisms made of rock crystal have been referred to as the birefringent optical members BP1, BP21 and BP22, but the compositions of the birefringent optical members are not limited to the above. For example, other crystal materials may be used for prisms, or each of the birefringent optical members may be composed of one wedge prism instead of cemented two prisms. Furthermore, a part of two or more wedge prisms may be made of an isotropic material such as a glass.

FIG. 7 shows an example of a slider for holding the birefringent optical member BP1. The slider is comprised of a slider body 31 and a holding frame 30 movably provided on the slider body 31 on which the birefringent optical member BP1 is mounted. The position of the holding frame 30 is adjustable in the longitudinal direction relative to the slider body 31. Specifically, the slider has an adjusting knob 32 projecting from the slider body 31 for external operation and the connecting shaft 33 disposed in the interior of the slider body 31 for connecting the adjusting knob 32 and the holding frame 30. The connecting shaft 33 is held in the interior of the slider body 31 by a certain friction mechanism in such a way that the connecting shaft is adjustable in the axial direction. The slider body 31 is mounted, in the vertical direction of the drawing sheet of FIG. 1, on a revolver (not shown) that holds the objective lens 3 shown in FIG. 1 so that the birefringent optical member BP1 would be finely adjusted in the vertical direction of the drawing sheet of FIG. 1 by manipulating the adjusting knob 32. The operator of the microscope can adjust the contrast of an image by adjusting the birefringent optical member BP1 while confirming the status of the observed image.

Specifically, the contrast of the observed sample can be adjusted by slightly shifting the adjusting knob 32 in the axial direction of the connecting shaft 33 so as to slightly shift the birefringent optical member BP1 in a direction perpendicular to the optical axis. In this case, it is preferable that the adjustment be performed without changing the angle of the birefringent optical member BP1, that is, under the state in which the birefringent optical member BP1 is fixed at a certain angle (i.e. at an optimum angle determined by the optical design). In other words, the inclination angle of the birefringent optical member BP1 with respect to the optical axis of the objective lens is so set that a pupil plane of the birefringent optical member BP1 and a pupil plane of the objective lens coincide with each other while the amount of unevenness is suppressed small (i.e. within the range of ±10 nm).

With these conditions being met, when the birefringent optical member BP1 is slightly shifted in the direction perpendicular to the optical axis for adjusting the contrast, the imaging performance of the optical system would not be deteriorated, since the two pupil planes coincide with each other. Therefore, an adverse influence on the balance of the amount of unevenness in the field of view can be advantageously avoided.

The reason why the inclination angle of the birefringent optical member BP1 is so set as described above is that, in some cases, it is impossible to set the pupil plane of the birefringent optical member BP1 to be perpendicular to the optical axis of the objective lens (in other words, the pupil plane of the birefringent optical member cannot coincide with the pulil plane of the objective lens), depending on the inclination angle between the crystal axis of the birefringent optical member BP1 and the optical axis of the objective lens.

Therefore, the optical system is designed taking the crystal axis of the birefringent optical member BP1 into account, and the inclination angle of the birefringent optical member is so set that the pupil plane of the birefringent optical member BP1 and the pupil plane of the objective lens coincide with each other while the amount of unevenness is suppressed small (i.e. within the range of ±10 nm).

In the foregoing, the invention has been described with reference to preferred embodiments. However, it should be noted that the embodiments described herein are mere explanatory examples, and the present invention is not limited to the structures or forms of those embodiments. Modifications and changes thereto can be made within the scope of the invention.

As per the above, according to the present invention, while only positive crystals that are inexpensive and easy to manufacture are used for birefringent optical members, it is possible to compensate crystal aberrations in the shear direction to eliminate unevenness on the imaging plane. Therefore, it is possible to obtain a good-quality differential interference image having a high contrast, which is especially suitable for photographing.

What is claimed is:

1. A differential interference microscope, in which polarized light having a predetermined direction of oscillation is incident on a birefringent optical member so as to be separated into two linearly polarized light components having directions of oscillation orthogonal to each other, and the two linearly polarized light components thus separated are directed via an objective lens to a sample to be observed, and the two linearly polarized light components reflected from the sample are guided via the objective lens to the birefringent optical member so as to be synthesized into single light, and two linearly polarized light components of the synthesized light flux are caused to interfere so that an image of the sample is formed by the objective lens from the light flux that have interfered, wherein said birefringent optical member has a wedge surface and a reference plane, and said birefringent optical member is inclined, in a plane including an optical axis and a normal line of said wedge surface, with respect to a plane perpendicular to an optical axis in a wedge angle direction by an angle that falls within the range of 16 to 40 degrees.

2. A differential interference microscope according to claim 1, wherein said birefringent optical member comprises a Nomarski prism.

3. A differential interference microscope, in which polarized light having a predetermined direction of oscillation is incident on a first birefringent optical member so as to be separated into two linearly polarized light components having directions of oscillation orthogonal to each other, and the two linearly polarized light components thus separated are directed via an illuminating optical system to a sample to be observed, and the two linearly polarized light components reflected from or transmitted through the sample are guided via an objective lens to a second birefringent optical member so as to be synthesized into single light, and two linearly polarized light components of the synthesized light flux are caused to interfere so that an image of the sample is formed by the objective lens from the light flux that have interfered, wherein each of said first and second birefringent optical members has a wedge surface and a reference plane, and at least one of said first and second birefringent optical members is inclined, in a plane including an optical axis and a normal line of said wedge surface, with respect to a plane perpendicular to an optical axis in a wedge angle direction by an angle that falls within the range of 16 to 40 degrees.

4. A differential interference microscope according to claim 3, wherein at least one of said first and second birefringent optical members comprises a Nomarski prism.

5. A differential interference microscope according to claim 1, wherein said birefringent optical member is mounted on a slider body so that said birefringent optical member can slide in a direction perpendicular to an optical axis of the objective lens.
